(19) United States
(12) Patent Application Publication
(10) Pub. No.: US 2017/0313374 A1
(43) Pub. Date: Nov. 2, 2017

(54) Bicycle accessories connection unit

(71) Applicant: MEGA COMPOSITE TECHNOLOGY CO., LTD., TAICHUNG CITY (TW)

(72) Inventor: Shu-Yi Chen, Taichung City (TW)

(21) Appl. No.: 15/141,827

(22) Filed: Apr. 29, 2016

(51) Int. Cl. B62J 11/00

(52) U.S. Cl. CPC B62J 11/00

(57) ABSTRACT

A bicycle accessories connection unit includes a body having an installation hole defined axially therethrough so as to be connected with an accessory. At least one connection hole are defined radially in the body and at least one connection member is connected to the at least one connection hole so as to be connected to another accessory. A link is connected between the body and a bicycle frame. Multiple accessory are connected to the single body.

### BACKGROUND OF THE INVENTION

### 1. Fields of the Invention

The present invention relates to a connection unit, and more particularly, to a bicycle accessories connection unit, multiple bicycle accessories are connected to the bicycle frame by the connection unit.

### 2. Descriptions of Related Art

There are multiple bicycle accessories developed such as speed-meters, Global Positioning System devices, recording devices and cellular phone stands, and these accessories each have a stand or connector which is first connected to the bicycle, and the accessories are respectively connected to or installed to the stands. For example, the recording device such as the product of the trademark “Go-Pro” can be attached to the helmet and creates a video of the travel of the cyclist. However, the recording device cannot be stably aim a certain direction so that the quality of the recording is not satisfied. Furthermore, if the cyclist wants to have multiple different accessories to be attached to the bicycle, multiple stands have to be connected to different parts of the bicycle such as the handlebar, the handlebar stein, and the head tube. Some of the stands and the accessories may interrupt the operation of the bicycles.

The present invention intends to provide a bicycle accessories connection unit, and multiple bicycle accessories are connected to the bicycle frame by using the connection unit.

### SUMMARY OF THE INVENTION

The present invention relates to a bicycle accessories connection unit and comprises a body having an installation hole defined axially therein which is connected with an accessory. At least one connection hole is defined radially through a wall of the body, and a link is connected to the body so as to be connected to a bicycle frame. At least one connection member is connected to the at least one connection hole and another accessory is connected to the at least one connection member.

Preferably, the body has a curved recess defined radially in the outer periphery thereof. The link has a connection portion connected to the first end thereof, and the connection portion is installed in the curved recess.

Preferably, the at least one connection member has a front end, a deformable portion and a flange. The deformable portion is located between the front end and the flange. The front end and the deformable portion extend through the at least one connection hole, and the deformable portion is applied by a force and deformed so that the periphery of the at least one connection hole is clamped between the deformable portion and the flange.

Preferably, the installation hole extends through the top and the bottom of the body.

Preferably, the at least one connection hole is located in the body and opposite to the link.

Preferably, the link has a plate connected to the second end thereof. The plate has a slot, and a bolt extends through the slot and is connected to the bicycle frame.

Preferably, the link has a plate connected to the second end thereof. The plate has a connection hole, and a bolt extends through the connection hole and is connected to the bicycle frame.

Preferably, adhesive is applied to the wall around the periphery of the at least one connection hole, the deformable portion and the flange.

Preferably, the at least one connection member is a rivet nut. Preferably, the body has a round, a rectangular or a polygonal cross section.

Preferably, the body is made of metal, aluminum alloy or carbon fibers.

The primary object of the present invention is to provide a bicycle accessories connection unit so that multiple bicycle accessories are connected to the bicycle frame by the single connection unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the bicycle accessories connection unit of the present invention;

FIG. 2 is a partial cross sectional view to show that the connection members are connected to the body of the bicycle accessories connection unit of the present invention;

FIG. 3 is an exploded view of the bicycle accessories connection unit of the present invention and a bicycle handlebar stein;

FIG. 4 is a perspective view to show that the bicycle accessories connection unit of the present invention is connected to the bicycle handlebar stein;

FIG. 5 shows that different bicycle accessories are to be connected to the bicycle accessories connection unit of the present invention;

FIG. 6 is a perspective view to show that the bicycle accessories in FIG. 5 are connected to the bicycle accessories connection unit of the present invention;

FIG. 7 is a perspective view to show that the bicycle accessories in FIG. 5 are connected to the bicycle accessories connection unit of the present invention which is connected to the bicycle handle stein;

FIG. 8 is an exploded view of a bicycle accessory is to be connected to the bicycle accessories connection unit of the present invention which is connected to the seat post;

FIG. 9 is an exploded view of another bicycle accessory is to be connected to the bicycle accessories connection unit of the present invention which is connected to the seat post;

FIG. 10 shows that another bicycle accessory is connected to the bicycle accessories connection unit of the present invention which is connected to the seat post;

FIG. 11 is an exploded view of the second embodiment of the bicycle accessories connection unit of the present invention;

FIG. 12 shows another embodiment of the connection of the body and the link of the bicycle accessories connection unit of the present invention, and

FIG. 13 shows another embodiment of the plate connected to the link of the bicycle accessories connection unit of the present invention.

### DETAILED DESCRIPTION OF THE PREFERRED EMBODIMENT

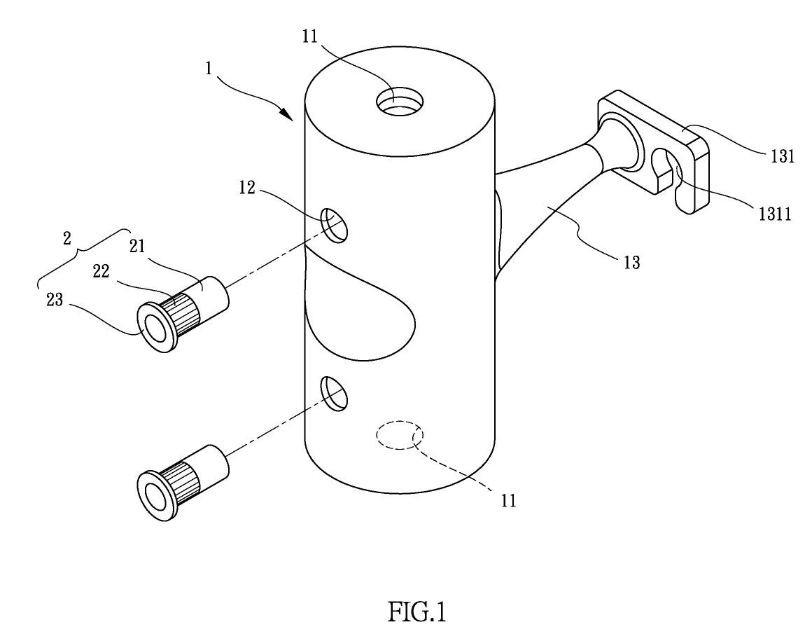

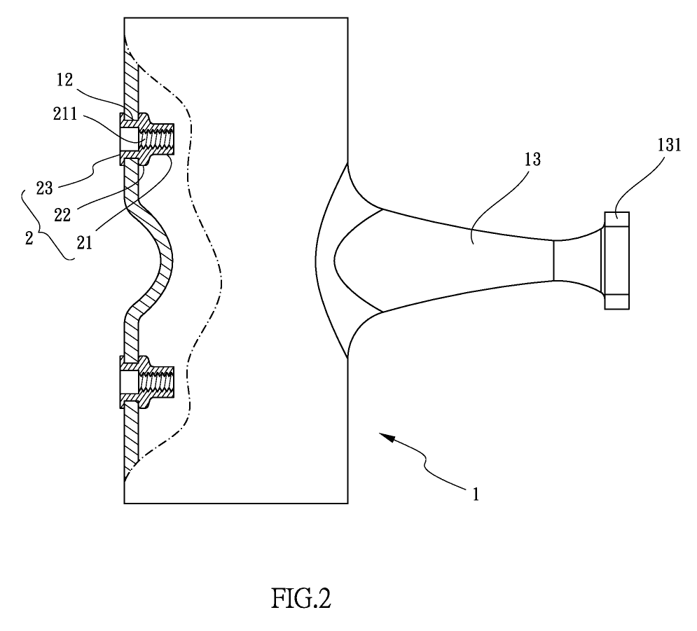

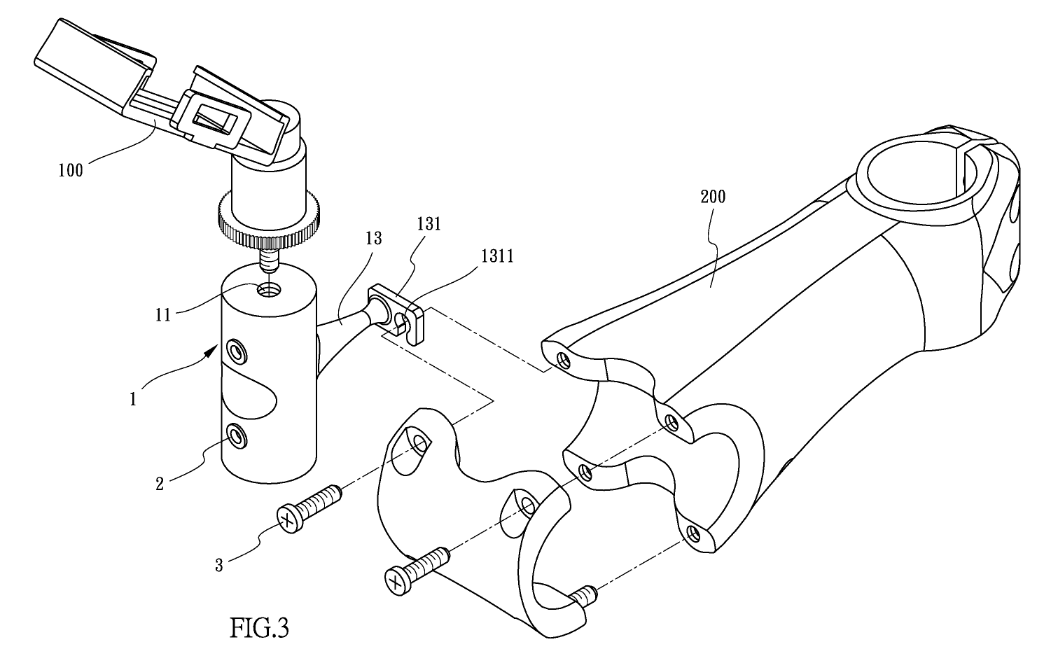

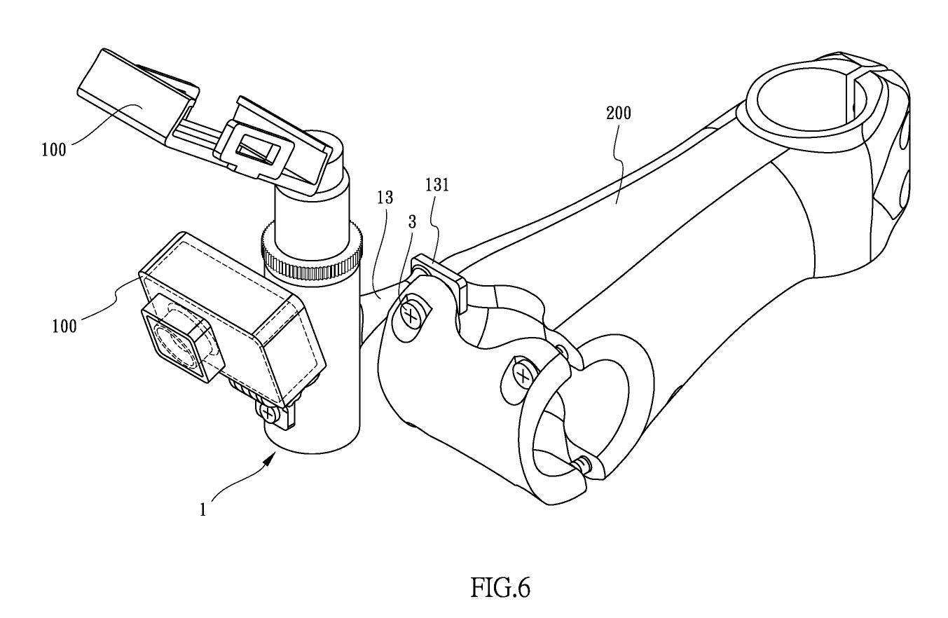

Referring to FIGS. 1 to 6, the bicycle accessories connection unit of the present invention comprises a body 1 having an installation hole 11 defined axially therein which is to be connected with an accessory 100. Two connection holes 12 are defined radially through the wall of the body 1. A link 13 is connected to the body 1 so as to be connected to a bicycle frame 200 such as the bicycle handlebar stein. Two connection members 2 are respectively connected to the two connection holes 12 and each connection member 2 is connected to another accessory 100, or another accessory 100 is connected to both of the two connection holes 12.

Specifically, the connection members 2 each have a front end 21, a deformable portion 22 and a flange 23, wherein the deformable portion 22 is located between the front end 21 and the flange 23. Preferably, the connection members 2 each are a rivet nut. The front end 21 and the deformable portion 22 extend through the connection hole 12 corresponding thereto, and a proper tool is used to apply a force to the deformable portion 22 which is then deformed so that the periphery of the connection hole 12 is clamped between the deformable portion 22 and the flange 23. The front end 21 of each connection member 2 has inner threads 211 defined therein so that the accessory 100 can be connected to the connection member 2 by a bolt or the like. Adhesive is applied to the wall around the periphery of the connection hole 12, the deformable portion 22 and the flange 23 so as to enhance the connection therebetween.

As shown in FIG. 1, the installation hole 11 extends through the top and the bottom of the body 1, such that two accessories 100 can be connected to the top and the bottom of the body 1.

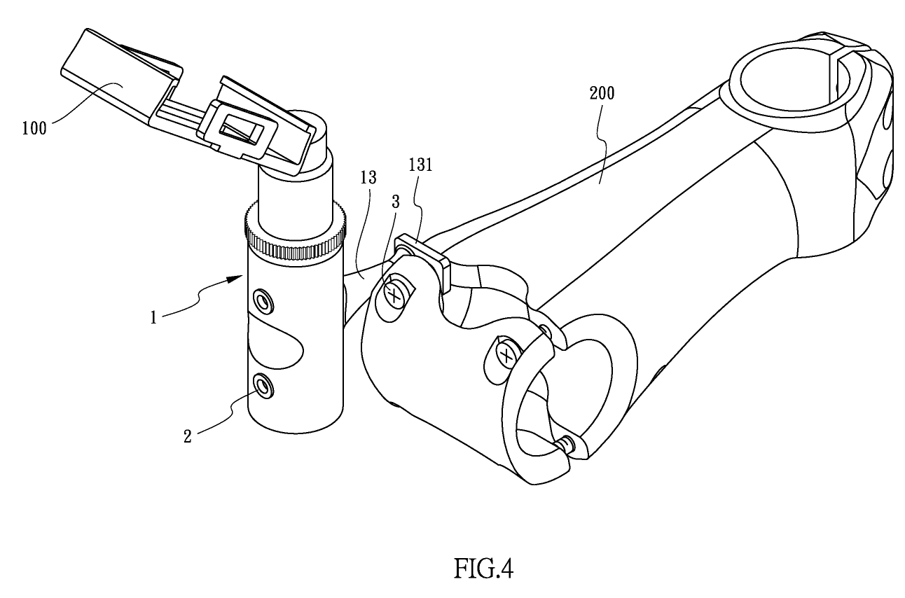

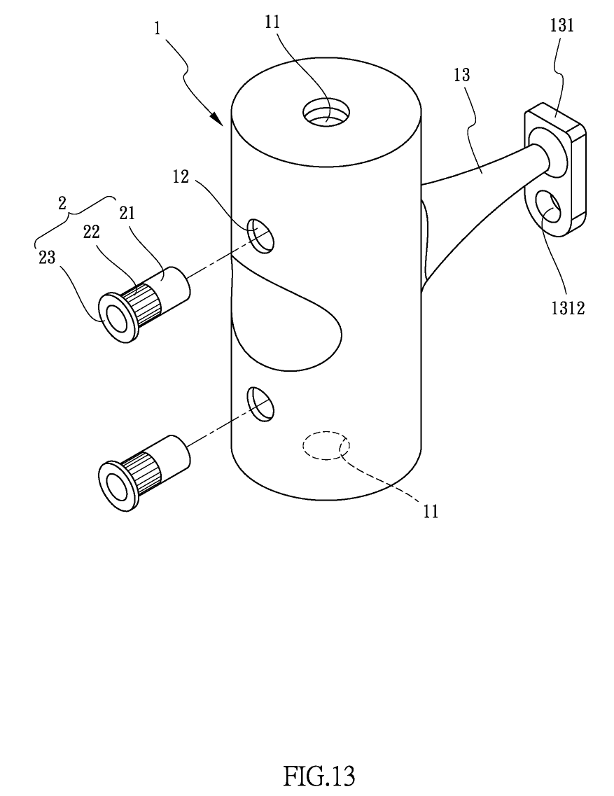

As shown in FIGS. 1, 3 and 4, the link 13 has a plate 131 connected to the second end thereof. The plate 131 has a slot 1311, and a bolt 3 extends through the slot 1311 and is connected to the bicycle frame 200. When installing the plate 131 to the bicycle frame 200 such as the handlebar stein, the bolts 3 are unscrewed from the handlebar stein and the plate 131 is positioned between the two parts of the handlebar stein, the two bolts 3 then extend through the two parts and the slot 1311 to fix the plate 131 to the handlebar stein as shown in FIG. 4. The steps are easy and can be completed quickly by the users. Alternatively, as shown in FIG. 13, the plate 131 may have a connection hole 1312, and the bolt 3 extends through the connection hole 1312 and is connected to the bicycle frame 200.

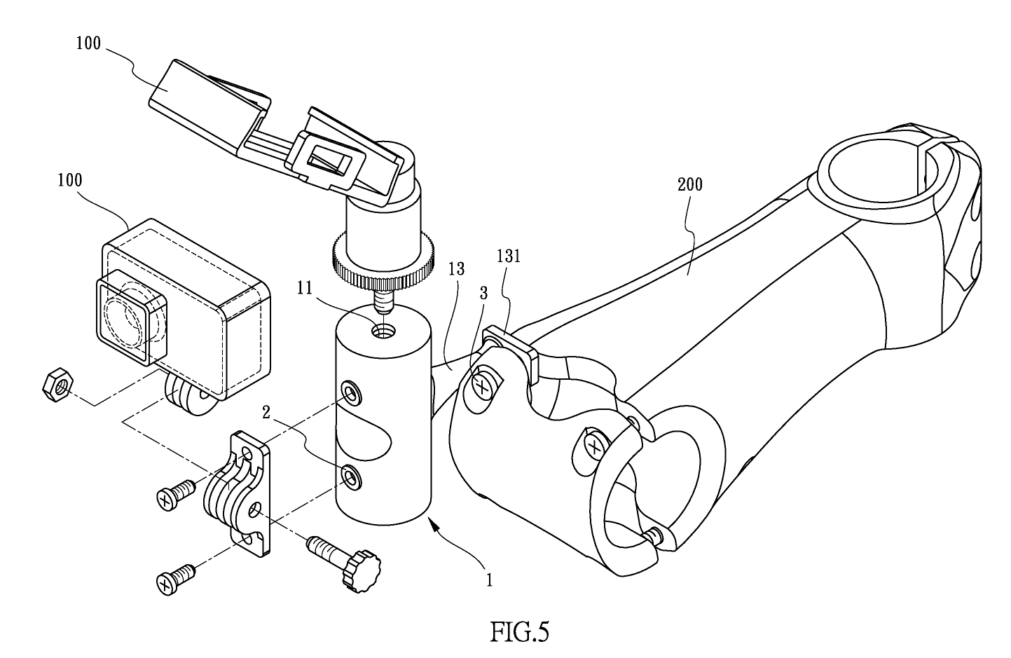

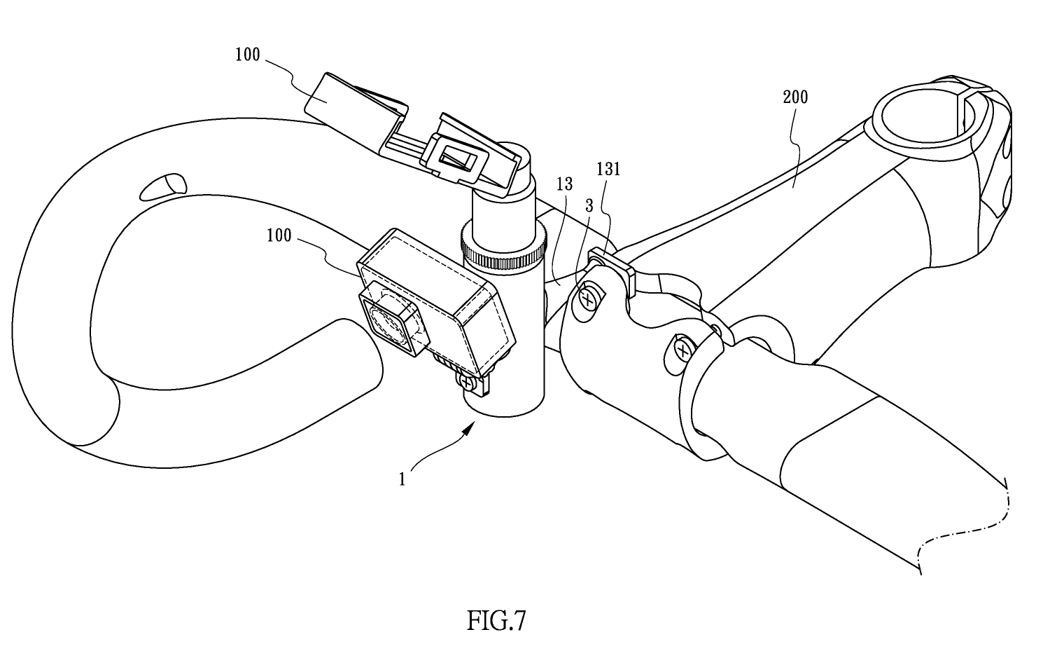

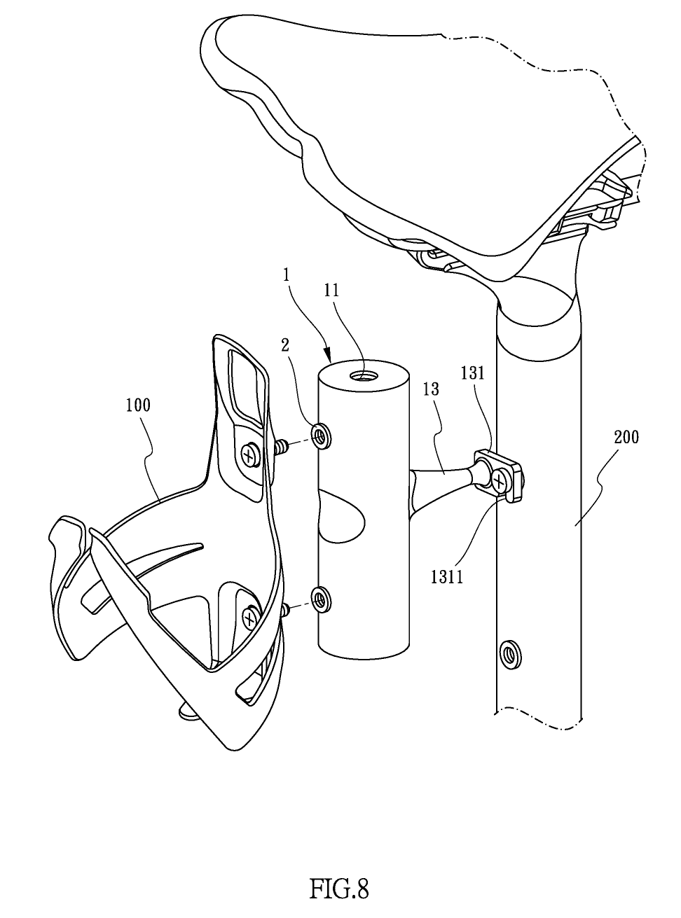

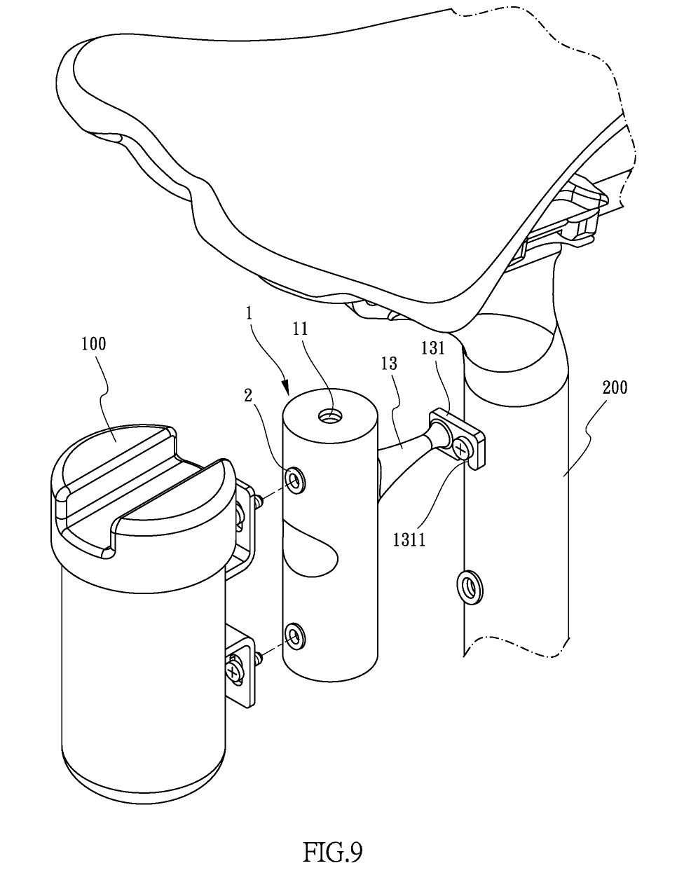

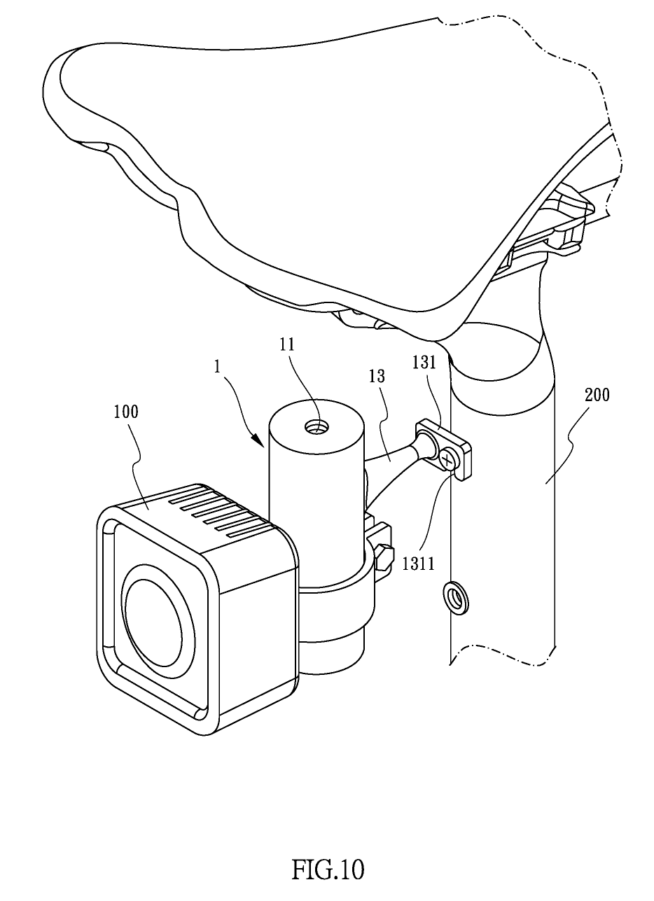

As shown in FIGS. 5 to 9, the body 1 can be cooperated with different accessories such as recording devices, cellular phones, water bottle support baskets, tool boxes or bicycle lights. As shown in FIG. 10, a C-clip can also be cooperated to fix an accessory to the body 1. In other words, the present invention can be cooperated with multiple accessories to the body 1.

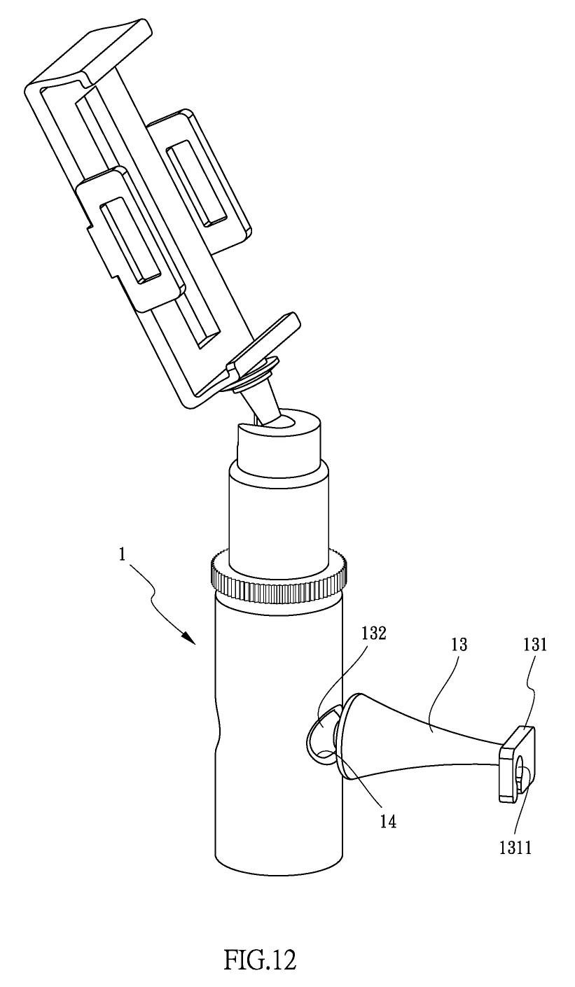

In another embodiment, the body 1 has a curved recess 14 defined radially in the outer periphery thereof and located in opposite to the two connection holes 12. The link 13 has a connection portion 132 connected to the first end thereof, and the connection portion 132 is installed in the curved recess 14. The body 1 is allowed to be pivoted relative to the connection portion 312 so that the users can adjust the body 1 toward a desired direction as shown in FIG. 12.

As shown in FIG. 1, at least one connection hole 12 is located in the body 1 and opposite to the link 13.

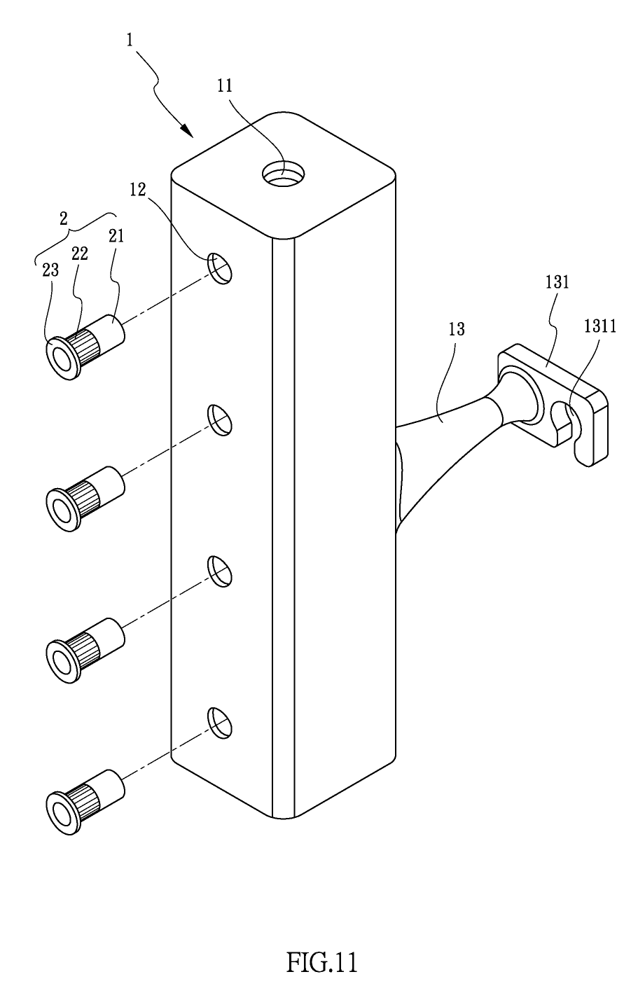

As shown in FIGS. 1 and 11, the body 1 has a round, a rectangular or a polygonal cross section, and the body 1 is made of metal, aluminum alloy or carbon fibers.

While we have shown and described the embodiment in accordance with the present invention, it should be clear to those skilled in the art that further embodiments may be made without departing from the scope of the present invention.

What is claimed is:

1. A bicycle accessories connection unit, comprising:
a body having an installation hole defined axially therein which is adapted to be connected with an accessory, at least one connection hole defined radially through a wall of the body, a link connected to the body and adapted to be connected to a bicycle frame, and
at least one connection member connected to the at least one connection hole and adapted to be connected to another accessory.

2. The bicycle accessories connection unit as claimed in claim 1, wherein the body has a curved recess defined radially in an outer periphery thereof, the link has a connection portion connected to a first end thereof, the connection portion is installed in the curved recess.

3. The bicycle accessories connection unit as claimed in claim 1, wherein the at least one connection member has a front end, a deformable portion and a flange, the deformable portion is located between the front end and the flange, the front end and the deformable portion extend through the at least one connection hole, and the deformable portion is applied by a force and deformed so that a periphery of the at least one connection hole is clamped between the deformable portion and the flange.

4. The bicycle accessories connection unit as claimed in claim 3, wherein the installation hole extends through a top and a bottom of the body.

5. The bicycle accessories connection unit as claimed in claim 4, wherein the at least one connection hole is located in the body and opposite to the link.

6. The bicycle accessories connection unit as claimed in claim 5, wherein the link has a plate connected to a second end thereof, the plate has a slot, a bolt extends through the slot and is adapted to be connected to the bicycle frame.

7. The bicycle accessories connection unit as claimed in claim 5, wherein the link has a plate connected to a second end thereof, the plate has a connection hole, a bolt extends through the connection hole and is adapted to be connected to the bicycle frame.

8. The bicycle accessories connection unit as claimed in claim 6, wherein adhesive is applied to a wall around the periphery of the at least one connection hole, the deformable portion and the flange.

9. The bicycle accessories connection unit as claimed in claim 7, wherein adhesive is applied to a wall around the periphery of the at least one connection hole, the deformable portion and the flange.

10. The bicycle accessories connection unit as claimed in claim 1, wherein the at least one connection member is a rivet nut.

11. The bicycle accessories connection unit as claimed in claim 1, wherein the body has a round, a rectangular or a polygonal cross section.

12. The bicycle accessories connection unit as claimed in claim 1, wherein the body is made of metal, aluminum alloy or carbon fibers.
